(19) United States
(12) Patent Application Publication
(10) Pub. No.: US 2025/0328732 A1
(43) Pub. Date: Oct. 23, 2025

(54) ADVANTAGE GENERATION FOR LANGUAGE MODEL

(71) Applicants: Beijing Zitiao Network Technology Co., Ltd., Beijing (CN); Bytedance Technology Ltd., Grand Cayman (KY)

(72) Inventors: Yu YUE, Beijing (CN); Yufeng YUAN, Beijing (CN); Qiying YU, Beijing (CN); Xiaochen ZUO, Beijing (CN); Ruofei ZHU, Beijing (CN); Wenyuan XU, Beijing (CN); Jiaze CHEN, Beijing (CN); Chengyi WANG, Beijing (CN); Tiantian FAN, Beijing (CN); Zhengyin DU, Beijing (CN); Xiangpeng WEI, Beijing (CN); Weihao GAO, Beijing (CN); Gaohong LIU, Beijing (CN); Juncai LIU, Beijing (CN); Lingjun LIU, Beijing (CN); Haibin LIN, Los Angeles, CA (US); Zhiqi LIN, Beijing (CN); Bole MA, Beijing (CN); Chi ZHANG, Beijing (CN); Mofan ZHANG, Beijing (CN); Wang ZHANG, Beijing (CN); Hang ZHU, Los Angeles, CA (US); Ru ZHANG, Beijing (CN); Xin LIU, Los Angeles, CA (US); Mingxuan WANG, Beijing (CN); Yonghui WU, Los Angeles, CA (US); Lin YAN, Beijing (CN)

(21) Appl. No.: 19/257,239

(22) Filed: Jul. 1, 2025

(51) Int. Cl. G06F 40/284; G06F 40/263

(52) U.S. Cl. CPC G06F 40/284; G06F 40/263

(57) ABSTRACT

There is provided a solution for advantage generation. In the solution, a value model is pretrained based on respective returns for respective first tokens in a first response of a plurality of first responses output by a trained reference model. A return for a first token indicates a cumulative reward from the first token to an end of the first response. Respective advantages for respective second tokens in a second response of a plurality of second responses output by a language model are generated based on the pretrained value model. An advantage for a second token indicates a cumulative reward for the second token relative to an average of cumulative rewards for candidate tokens at a position of the second token.

### FIELD

The present disclosure generally relates to computer technologies, and more specifically, to a method, apparatus, device and computer readable storage medium for advantage generation.

### BACKGROUND

Reasoning models (e.g., a language model) have advanced artificial intelligence by exhibiting performance in complex tasks such as mathematical reasoning, which demand step-by-step analysis and problem-solving through long chain-of-thought (CoT) at test time. Reinforcement learning (RL) plays a pivotal role in the success of these models. It gradually enhances the model's performance by continuously exploring reasoning paths toward correct answers on verifiable problems, achieving reasoning capabilities.

### SUMMARY

In a first aspect of the present disclosure, there is provided a method of advantage generation. The method comprises: pretraining a value model based on respective returns for respective first tokens in a first response of a plurality of first responses output by a trained reference model, a return for a first token indicating a cumulative reward from the first token to an end of the first response; and generating, at least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

In a second aspect of the present disclosure, there is provided an apparatus for advantage generation. The apparatus comprises: a pretraining module configured to pretrain a value model based on respective returns for respective first tokens in a first response of a plurality of first responses output by a trained reference model, a return for a first token indicating a cumulative reward from the first token to an end of the first response; and a generating module configured to generate, at least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

In a third aspect of the present disclosure, there is provided an electronic device. The electronic device comprises: at least one processor; and at least one memory coupled to the at least one processor and storing instructions executable by the at least one processor, the instructions, upon execution by the at least one processor, causing the electronic device to perform: pretraining a value model based on respective returns for respective first tokens in a first response of a plurality of first responses output by a trained reference model, a return for a first token indicating a cumulative reward from the first token to an end of the first response; and generating, at least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

In a fourth aspect of the present disclosure, a computer-readable storage medium is provided. The computer-readable storage medium stores computer executable instructions which, when executed by an electronic device, causes the electronic device perform operations comprising: pretraining a value model based on respective returns for respective first tokens in a first response of a plurality of first responses output by a trained reference model, a return for a first token indicating a cumulative reward from the first token to an end of the first response; and generating, at least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

The above and other features, advantages and aspects of the embodiments of the present disclosure will become more apparent in combination with the accompanying drawings and with reference to the following detailed description. In the drawings, the same or similar reference symbols refer to the same or similar elements, where:

FIG. 1 illustrates a schematic diagram of an example environment in which embodiments of the present disclosure may be implemented;

FIG. 2 illustrates a schematic diagram of an architecture of advantage generation in accordance with some embodiments of the present disclosure;

FIG. 3 illustrates a flowchart of a process for advantage generation in accordance with some embodiments of the present disclosure;

FIG. 4 shows a block diagram of an apparatus for advantage generation in accordance with some embodiments of the present disclosure; and

FIG. 5 illustrates a block diagram of an electronic device in which one or more embodiments of the present disclosure can be implemented.

### DETAILED DESCRIPTION

The embodiments of the present disclosure will be described in more detail below with reference to the accompanying drawings. Although some embodiments of the present disclosure are shown in the drawings, it would be appreciated that the present disclosure may be implemented in various forms and should not be interpreted as limited to the embodiments described herein. On the contrary, these embodiments are provided for a more thorough and complete understanding of the present disclosure. It would be appreciated that the drawings and embodiments of the present disclosure are only for the purpose of illustration and are not intended to limit the scope of protection of the present disclosure.

In the description of the embodiments of the present disclosure, the term “including” and similar terms would be appreciated as open inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. As used herein, the term “model” can represent the matching degree between various data. For example, the above matching degree can be obtained based on various technical solutions currently available and/or to be developed in the future.

It will be appreciated that the data involved in this technical proposal (including but not limited to the data itself, data acquisition or use) shall comply with the requirements of corresponding laws, regulations and relevant provisions.

It will be appreciated that before using the technical solution disclosed in each embodiment of the present disclosure, users should be informed of the type, the scope of use, the use scenario, etc. of the personal information involved in the present disclosure in an appropriate manner in accordance with relevant laws and regulations, and the user's authorization should be obtained.

For example, in response to receiving an active request from a user, a prompt message is sent to the user to explicitly prompt the user that the operation requested operation by the user will need to obtain and use the user's personal information. Thus, users may select whether to provide personal information to the software or the hardware such as an electronic device, an application, a server or a storage medium that perform the operation of the technical solution of the present disclosure according to the prompt information.

As an optional but non-restrictive implementation, in response to receiving the user's active request, the method of sending prompt information to the user may be, for example, a pop-up window in which prompt information may be presented in text. In addition, pop-up windows may also contain selection controls for users to choose “agree” or “disagree” to provide personal information to electronic devices.

It will be appreciated that the above notification and acquisition of user authorization process are only schematic and do not limit the implementations of the present disclosure. Other methods that meet relevant laws and regulations may also be applied to the implementation of the present disclosure.

As used herein, the term “model” can learn a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. A neural networks model is an example of a deep learning-based model. As used herein, “model” may also be referred to as “machine learning model”, “learning model”, “machine learning network”, or “learning network”, and these terms are used interchangeably herein.

“Neural networks” are a type of machine learning network based on deep learning. Neural networks are capable of processing inputs and providing corresponding outputs, typically comprising input and output layers and one or more hidden layers between the input and output layers. Neural networks used in deep learning applications typically comprise many hidden layers, thereby increasing the depth of the network. The layers of neural networks are sequentially connected so that the output of the previous layer is provided as input to the latter layer, where the input layer receives the input of the neural network and the output of the output layer serves as the final output of the neural network. Each layer of a neural network comprises one or more nodes (also known as processing nodes or neurons), each of which processes input from the previous layer.

Usually, machine learning can roughly comprise three stages, namely training stage, test stage, and application stage (also known as inference stage). During the training stage, a given model can be trained using a large scale of training data, iteratively updating parameter values until the model can obtain consistent inference from the training data that meets the expected objective. Through the training, the model can be considered to learn the correlation between input and output (also known as input-to-output mapping) from the training data. The parameter values of the trained model are determined. In the test stage, test inputs are applied to the trained model to test whether the model can provide correct outputs, thereby determining the performance of the model. In the application stage, the model can be used to process actual inputs and determine corresponding outputs based on the parameter values obtained from training.

Natural language processing (NLP) is an important direction in the computer science field and the artificial intelligence field. It studies various theories and methods that can implement effective communication between people and computers by using natural languages. NLP is a comprehensive science of linguistics, computer science, and mathematics. Therefore, research in this field involves natural languages, that is, languages that people use on a daily basis, and therefore, is closely related to the study of linguistics. NLP technologies include technologies such as text processing, semantic understanding, machine translation, robot query and answer, and knowledge graphs. The application of some embodiments to NLP technology mainly involves extracting features in text modal data by using a feature extraction model.

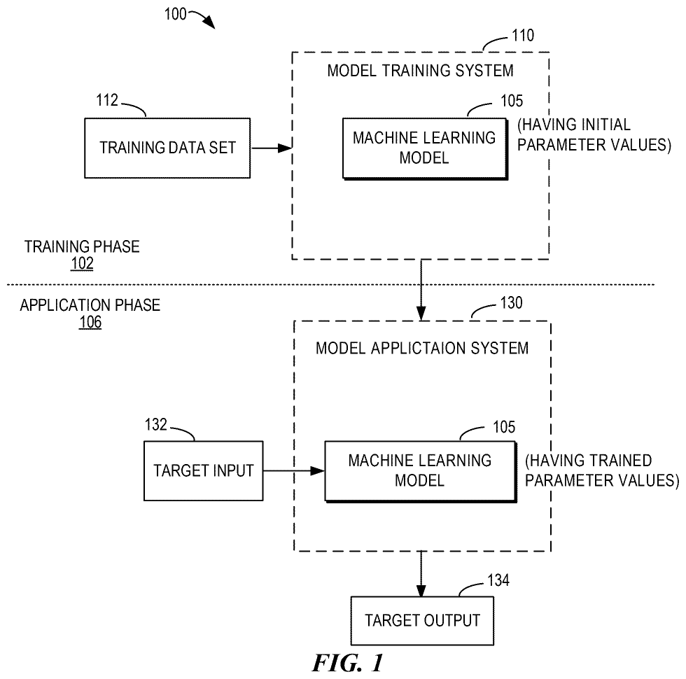

FIG. 1 illustrates a block diagram of an example environment 100 in which various embodiments of the present disclosure may be implemented. In the environment 100 of FIG. 1, two distinct phases of a model are shown, including a training phase 102 and an application phase 106. After the training phase 102 is completed, there may be a testing phase, which is not shown in FIG. 1.

In the training phase 102, a model training system 110 is configured to utilize a training dataset 112 to perform training of the machine learning model 105. At the beginning of training, the machine learning model 105 may have initial parameter values. The training process is to update the parameter values of the machine learning model 105 to the expected values based on the training data. In some embodiments, the machine learning model 105 is configured to generate a response based on a given prompt.

In the application phase 106, the machine learning model 105 having trained parameter values may be provided to a model application system 130 for use. In the application phase 106, the machine learning model 105 may be used to process a target input 132 and provide a corresponding target output 134.

In FIG. 1, the model training system 110 and the model application system 130 may be implemented at any computing system with computing capability, such as various computing devices/systems, terminal devices, servers, etc. Terminal devices may include any type of mobile terminals, fixed terminals, or portable terminals, including mobile phones, desktop computers, laptops, netbooks, tablets, media computers, multimedia tablets, or any combination of the aforementioned, including accessories and peripherals of these devices or any combination thereof. Servers include but are not limited to mainframe, edge computing nodes, computing devices in cloud environment, etc.

It should be understood that the structure and function of each element in the environment 100 is described for illustrative purposes only and does not imply any limitations on the scope of the present disclosure. In an example, although shown as separate, the model training system 110 and the model application system 130 may be integrated into a same system or device. The implementation method disclosed herein is not limited in this regard.

In the RL training of a language model, value-model-free approaches have demonstrated effectiveness. These approaches eliminate the computational overhead of learning a value model, instead computing an advantage solely based on the final reward of the entire trajectory. The trajectory-level advantage is then directly assigned as the token-level advantage for each position in the sequence. When training a reliable value model is challenging, value-model-free approaches deliver an accurate and stable baseline for advantage calculation by averaging the rewards across multiple trajectories within a group. This group-based reward aggregation mitigates the need for explicit value estimation, which often suffers from instability in complex tasks. Consequently, value-model-free approaches have gained significant attraction in addressing difficult problems such as long cot reasoning, with substantial research efforts focused on optimizing their frameworks.

Despite the success achieved by the value-model-free approaches, value-model-based approaches may possess a higher performance ceiling if the challenges in training value models can be addressed. Firstly, value models enable more precise credit assignment by accurately tracing the impact of each action on subsequent returns, facilitating finer-grained optimization. This is critical for complex reasoning tasks, where subtle errors in individual steps often lead to catastrophic failures, and it remains challenging for model optimizing under value-model-free frameworks. Secondly, in contrast to the advantage estimates derived from Monte Carlo methods in value-model-free approaches, value models may provide lower-variance value estimates for each token, thereby enhancing training stability. Furthermore, a well-trained value model exhibits inherent generalization capabilities, enabling more efficient utilization of samples encountered during online exploration. This elevates the optimization ceiling of reinforcement learning algorithms. Consequently, despite the challenges in training value models for complex problems, the potential benefits of overcoming these difficulties are substantial.

However, training a perfect value model in long CoT tasks presents significant challenges. First, learning a low-bias value model is non-trivial given the long trajectory and the instability of learning value in a bootstrapped way. Second, handling both short and long responses simultaneously is also challenging, as they might exhibit very distinct preferences towards the bias-variance trade-off during optimization. Last but not least, the sparsity of the reward signal from verifiers is further exacerbated by the long CoT pattern, which intrinsically requires better mechanisms to balance exploration and exploitation.

RL centers around the learning of a policy that maximizes the cumulative reward for an agent as it interacts with an environment. In the present disclosure, language generation tasks may be casted within the framework of a Markov Decision Process (MDP).

A prompt may be denoted as x and a response to this prompt may be denoted as y. Both x and y may be decomposed into sequences of tokens. For example, the prompt x may be expressed as x=(x₀, . . . , xₘ), where tokens are drawn from a fixed discrete vocabulary.

[symbol]

The token-level MDP may be defined as the tuple [symbol] =( [symbol] , [symbol] , [symbol] , R, d₀, ω). Specifically, [symbol] represents a state space which encompasses all possible states formed by the tokens generated up to a given time step. At time step t, the state sₜ is defined as sₜ=(x₀, . . . , xₘ, y₀, . . . , yₜ). [symbol] represents an action space which corresponds to the fixed discrete vocabulary, from which tokens are selected during the generation process. [symbol] denotes dynamics which represent a deterministic transition model between tokens. Given a state sₜ=(x₀, . . . , xₘ, y₀, . . . , yₜ), an action α=yₜ₊₁, and the subsequent state sₜ₊₁=(x₀, . . . , xₘ, y₀, . . . , yₜ, yₜ₊₁), the probability [symbol] (sₜ₊₁|sₜ, α)=1. ω represents a termination action. The language generation process concludes when the terminal action ω, typically the end-of-sentence token, is executed. R(s, α) represents a reward function which offers scalar feedback to evaluate the agent's performance after taking action α in state s. In the context of reinforcement learning from human feedback (RLHF), the reward function may be learned from human preferences or defined by a set of rules specific to the task. d₀ represents an initial state distribution which is a probability distribution over prompts x. An initial state s₀ includes the tokens within the prompt x.

An optimization problem may be formulated as a KL-regularized RL task. The objective is to approximate the optimal KL-regularized policy, which is given by:

$${π}^{*} = arg {max}_{π} {𝔼}_{π , {s}_{0} \sim {d}_{0}} [ {\sum }_{t = 0}^{H} R ( {s}_{t} , {a}_{t} ) - β KL ( π ( \cdot \vert {s}_{t} ) ‖ {π}_{ref} ( \cdot \vert {s}_{t} ) ) ) ] \qquad ( 1 )$$

In Eq. (1), H represents the total number of decision steps, s₀ represents a prompt sampled from the dataset, R(sₜ, αₜ) represents the token-level reward obtained from the reward function, β represents a coefficient that controls the strength of the KL-regularization, and π_{ref} represents an initialization policy. In traditional RLHF and most tasks related to language models, the reward is sparse and is only assigned at the terminal action ω, that is, the end-of-sentence token <EOS>.

Proximal policy optimization (PPO) uses a clipped surrogate objective to update the policy. The key idea is to limit the change in the policy during each update step, preventing large policy updates that could lead to instability. Let π_{θ}(αₜ|sₜ) be the policy parameterized by θ, and π_{θ}_{_{old}} (αₜ|sₜ) be the old policy from the previous iteration. The surrogate objective function for PPO is defined as follows:

$${ℒ}^{CLIP} ( θ ) = {\hat{𝔼}}_{t} [ min ( {r}_{t} ( θ ) {Â}_{t} , clip ( {r}_{t} ( θ ) , 1 - ϵ , 1 + ϵ ) {Â}_{t} ) ] \qquad ( 2 )$$

In Eq. (2),

$${r}_{t} ( θ ) = \frac{{π}_{θ} ( {a}_{t} \vert {s}_{t} )}{{π}_{{θ}_{old}} ( {a}_{t} \vert {s}_{t} )}$$

represents the probability ratio, Âₜ represents the estimated advantage at time step t, and ϵ represents a hyperparameter that controls the clipping range.

Generalized advantage estimation (GAE) is a technique used to estimate the advantage function more accurately in PPO. It combines multiple step bootstrapping to reduce the variance of the advantage estimates. For a trajectory of length T, the advantage estimate Âₜ at time step t is computed as follows:

$${Â}_{t} = {\sum }_{l = 0}^{T - t - 1} {( γ λ )}^{l} {δ}_{t + l} \qquad ( 3 )$$

In Eq. (3), γ represents the discount factor, Δϵ[0,1] represents the GAE parameter, δₜ=R(sₜ, αₜ)+γV(sₜ₊₁)−V(sₜ) represents the temporal-difference (TD) error. Here, R(sₜ, αₜ) represents the reward at time step t, and V(s) represents the value function. Since it is a common practice to use discount factor γ=1.0 in RLHF, to simplify the notation, γ is omitted in the following paragraphs of the present disclosure.

Long CoT tasks present unique challenges to RL training, especially for approaches that employ a value model to reduce variance. The technical issues arising from sequence length dynamics, value function instability, and reward sparsity may be systematically analyzed in the following.

Initializing the value model with a reward model introduces significant initialization bias. This initialization bias (also referred to as a positive bias) arises from an objective mismatch between the two models. The reward model is trained to score on the <EOS> token, incentivizing it to assign lower scores to earlier tokens due to their incomplete context. In contrast, the value model estimates the expected cumulative reward for all tokens preceding <EOS> under a given policy. During early training phases, given the backward computation of GAE, there will be a positive bias at every timestep t that accumulates along the trajectory.

Another standard practice of using GAE with λ=0.95 may exacerbate this issue. The reward signal R(s_{T}, <EOS>) at the termination token propagates backward as λ^{T-t} (s_{T}, <EOS>) to the t-th token. For long sequences where T−t»1, this discounting reduces the effective reward signal to near zero. Consequently, value updates become almost entirely bootstrapped, relying on highly biased estimates that undermine the role of the value model as a reliable variance-reduction baseline.

In complex reasoning tasks where a long CoT is essential for arriving at the correct answer, models often generate responses with highly variable lengths. This variability requires algorithms to be robust enough to manage sequences that can range from very short to extremely long. As a result, the commonly applied GAE approach with a fixed A parameter encounters significant challenges.

Even when the value model is perfect, a static A may not effectively adapt to sequences of varying lengths. For short-length responses, the estimates obtained through GAE tend to suffer from high variance. This is because GAE represents a trade-off between bias and variance. In the case of short responses, the estimates are skewed towards the variance-dominated side. On the other hand, for long-length responses, GAE often leads to high bias due to bootstrapping. The recursive nature of GAE, which relies on future state values, accumulates errors over long sequences, exacerbating the bias issue. These limitations are deeply rooted in the exponentially decaying nature of GAE's computational framework.

Complex reasoning tasks frequently deploy a verifier as a reward model. Unlike traditional language-model-based reward models that provide a dense signal, such as a continuous value ranging from −4 to 4, verifier-based reward models typically offer binary feedback, such as 0 and 1. The sparsity of the reward signal is further compounded by long CoT reasoning. As CoT significantly elongates output lengths, it not only increases computational time but also reduces the frequency of receiving non-zero rewards. In policy optimization (e.g., optimization of a language model), the sampled responses with correct answers could be scarce and valuable.

This situation poses a distinct exploration-exploitation dilemma. On one hand, the model (e.g., a language model) should maintain relatively high uncertainty. This enables it to sample a diverse range of responses, increasing the likelihood of generating the correct answer for a given prompt. On the other hand, algorithms need to effectively utilize the correctly sampled responses, obtained through painstaking exploration, to enhance learning efficiency. By failing to strike the right balance between exploration and exploitation, the model may either get stuck in suboptimal solutions due to excessive exploitation or waste computational resources on unproductive exploration.

In order to solve the issues in the value model, embodiments of the present disclosure propose an improved solution for advantage generation. In this solution, a value model is pretrained based on respective returns for respective first tokens in a first response of a plurality of first responses output by a trained reference model. A return for a first token indicates a cumulative reward from the first token to an end of the first response. Respective advantages for respective second tokens in a second response of a plurality of second responses output by a language model are generated based on the pretrained value model. An advantage for a second token indicates a cumulative reward for the second token relative to an average of cumulative rewards for candidate tokens at a position of the second token.

With these embodiments of the present disclosure, more accurate advantages for assessing actions performed by the language model may be generated based on the pretrained value model. In this way, the efficiency of training the language model may be improved.

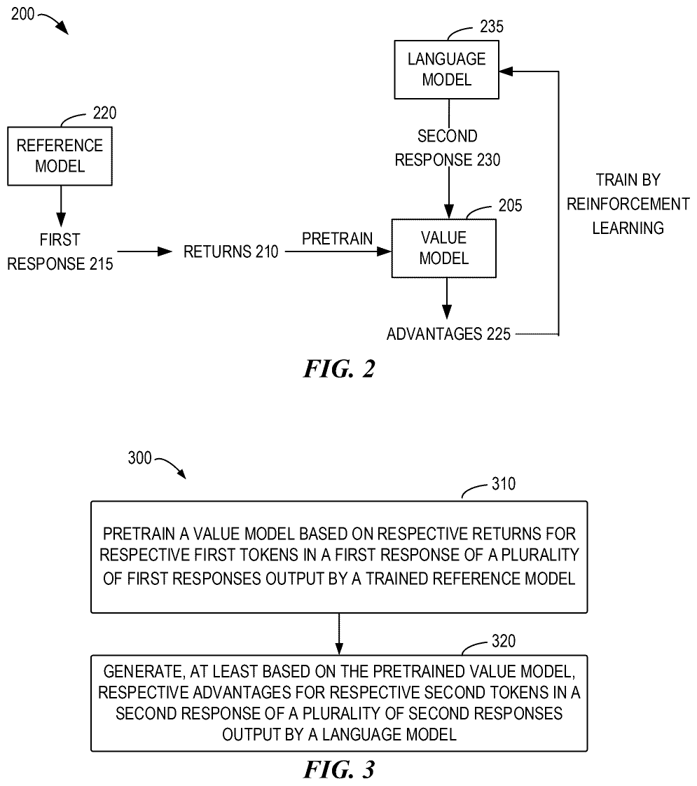

Example embodiments of the present disclosure will be described with reference to the drawings. FIG. 2 illustrates a schematic diagram of an architecture 200 of advantage generation in accordance with some embodiments of the present disclosure. As shown in FIG. 2, a value model 205 is pretrained based on respective returns 210 for respective first tokens in a first response 215 of a plurality of first responses output by a trained reference model 220. A return for a first token indicates a cumulative reward from the first token to an end of the first response 215. In some solutions, naively applying PPO to long CoT tasks lead to failures such as collapsed output lengths and degraded performance. The reason is that the value model 205 is initialized from the reward model while the reward model shares a mismatched objective with the value model and a value initialization bias is introduced. The value model 205 is pretrained to mitigate the value initialization bias.

In some examples, the plurality of first responses may be continuously generated by sampling from the reference model 220 (also referred to as a fixed policy, denoted as π_{sft}) given at least one prompt (e.g., a query). Respective returns 210 for respective tokens in the first response 215 may be obtained. For example, the respective returns 210 may be obtained using GAE (e.g., Eq. (3)) with λ=1.0 and the respective returns 210 may be regarded as Monte-Carlo returns.

In some embodiments, respective predicted value scores for the respective first tokens in the first response may be generated using the value model. Then, respective differences between the respective returns and the respective predicted value scores may be determined and the value model 205 may be pretrained based on the respective differences. In some examples, the respective returns may be regarded as ground-truth and a mean squared error (MSE) loss may be constructed based on the respective differences. The value model 205 may be trained until key training metrics, including the MSE loss and an explained variance, attain sufficiently low values. In some examples, a checkpoint for the pretrained value model 205 may be saved and this checkpoint may be loaded for subsequent usage. It is to be noted that the MSE loss is only an example of training metrics and other appropriate training metrics may be used to train the value model. In this way, the bias caused by the reward model may be eliminated and thus the value model 205 may estimate long-term returns accurately.

After pretraining the value model 205, respective advantages 225 for respective second tokens in a second response 230 of a plurality of second responses output by a language model 230 are generated at least based on the pretrained value model 205. Generally, an advantage may measure how much better a specific action is compared to the average action in a given state. An advantage for a second token indicates a cumulative reward for the second token relative to an average of cumulative rewards for candidate tokens at a position of the second token. In this way, more accurate advantages may be generated based on the pretrained value model.

The advantage computation for the value model 205 and the language model 235 may be decoupled. In some embodiments, the respective returns 210 (as an example of the advantage computation for the value model 205) may be determined using GAE. A tuning parameter in the GAE for determining the respective returns 210 may be set to a first value based on a dependency of the respective returns 210 on a long term reward. In some examples, the tuning parameter may be λ in Eq. (3), which indicates the dependency of the respective returns 210 on the long term reward and λ may be set to 1 or another value (as an example of the first value). The larger the value of λ, the higher the dependency of the respective returns 210 on the long term reward. For the updates of the value model 205, the update target of the value model 205 may be computed with λ=1. In this way, an unbiased gradient-descent optimization may be achieved, and reward-decay issues may be effectively addressed in long CoT tasks.

In some embodiments, the respective advantages 225 (as an example of the advantage computation for the language model 235) may be determined using GAE. A tuning parameter in the GAE for determining the respective advantages 225 may be set to a second value based on a dependency of the respective advantages on a long term reward. In some examples, the tuning parameter may be λ in Eq. (3) and λ may be set to the second value (e.g., 0.95) smaller than the first value. For the updates of the language model 235, a smaller λ may be used to accelerate policy convergence under computational and time constraints.

In some solutions, the value of the tuning parameter (denoted as λ_{policy}) in the GAE for determining the respective advantages is set to a constant value (i.e., 0.95). However, when considering the GAE computation, longer output sequences with lengths l>100, the coefficient of the TD-error corresponding to the reward is 0.95¹⁰⁰≈0.006, which is effectively zero. As a result, with a fixed λ_{policy}=0.95, the GAE computation becomes dominated by potentially biased bootstrapping TD-errors. This approach may not be optimal for handling extremely long output sequences.

To address the challenge of heterogeneous sequence lengths during training, length-adaptive GAE may be proposed. In some embodiments, the second value (e.g., the value of the λ_{policy}) may be further based on a length of the second response 230 of the plurality of second responses. In some examples, the sum of the coefficients λ_{policy} may be proportional to the length l of the second response 230, which may be shown as follows:

$${\sum }_{t = 0}^{∞} {λ}_{policy}^{t} \approx \frac{1}{1 - {λ}_{policy}} = α l , \qquad ( 4 )$$

In Eq. (4), a represents hyper-parameter controlling the overall bias-variance trade-off. By solving Eq. (4) for λ_{policy}, the value of λ_{policy} may be derived as follows:

$${λ}_{policy} = 1 - \frac{1}{α l} \qquad ( 5 )$$

In this way, the length-adaptive approach to λ_{policy} in GAE computation enables adaptive advantage estimation for sequences of varying lengths and allows for a more effective handling of sequences of varying lengths.

In some embodiments, the language model 235 may be trained by reinforcement learning based on the respective advantages 225. A training objective of the reinforcement learning is configured to increase at least one of the respective advantages 225.

In some solutions, the loss used (also referred to as a policy gradient loss) for training language model 235 is computed as follows:

$${ℒ}_{PPO} ( θ ) = - \frac{1}{G} {\sum }_{i = 1}^{G} \frac{1}{\vert {o}_{i} \vert} {\sum }_{t = 1}^{\vert {o}_{t} \vert} min ( {r}_{i , t} ( θ ) {Â}_{i , t} , clip ( {r}_{i , t} ( θ ) , 1 - ε , 1 + ε ) {Â}_{i , t} ) , \qquad ( 6 )$$

In Eq. (6), [symbol] _{PPO}(θ) represents the first loss, G represents the size of a training batch, oᵢ represents the trajectory of the i-th sample, Â_{i,t} represents an advantage for a token and ϵ represents a clipping parameter. In this loss formulation, the losses of all tokens are first averaged at the sequence level before being further averaged at the batch level. This approach results in tokens from longer sequences contributing less to the final loss value. Consequently, if the model (e.g., the language model 235) encounters critical issues in processing long sequences, a scenario that is prone to occur during the exploration phase of RL training, the insufficient suppression caused by their diminished weighting may lead to training instability or even collapse.

To address this imbalance in token-level contribution to the final loss, in some embodiments, respective individual losses for the respective second tokens in the second response 230 may be determined. A first loss (e.g., the policy gradient loss) may be obtained based on a sum of the respective individual losses and the number of the respective second tokens. In an example, the first loss may be obtained by dividing the sum of the respective individual losses by the number of the respective second tokens. Then, the language model 235 may be trained based on the first loss. In some examples, the first loss may be computed as follows:

$${ℒ}_{PPO} ( θ ) = - \frac{1}{{\sum }_{i = 1}^{G}} \frac{1}{\vert {o}_{i} \vert} {\sum }_{t = 1}^{\vert {o}_{t} \vert} min ( {r}_{i , t} ( θ ) {Â}_{i , t} , clip ( {r}_{i , t} ( θ ) , 1 - ε , 1 + ε ) {Â}_{i , t} ) , \qquad ( 7 )$$

In Eq. (7), all tokens within a single training batch are assigned uniform weights, thereby enabling the problems posed by long sequences to be addressed with enhanced efficiency. In this way, the training stability of mixed-length sequences may be enhanced.

In some embodiments, a change between the language model and the language model after training is limited to a range. A distance between an upper limit of the range and a baseline of the range is greater than a distance between a lower limit of the range and the baseline. In some examples, the first loss may be computed as follows:

$$( 8 )$$

$${ℒ}_{PPO} ( θ ) = - \frac{1}{{Σ}_{i = 1}^{G} \vert {o}_{i} \vert} {\sum }_{i = 1}^{G} {\sum }_{t = 1}^{\vert {0}_{t} \vert} min ( {r}_{i , t} ( θ ) {Â}_{i , t} , clip ( {r}_{i , t} ( θ ) , 1 - {ε}_{low} , 1 + {ε}_{high} ) {Â}_{i , t} )$$

In Eq. (8), r_{i,t}(θ) represents a change between the language model 235 and the language model 235 after training, clip(r_{i,t}(θ),1−ϵ_{low}, 1+ϵ_{high}) represents the change is limited to a range, ϵ_{low} represents a distance between a lower limit (i.e., 1−ϵ_{low}) of the range and the baseline (i.e., 1) of the range, ϵ_{high} represents a distance between an upper limit (i.e., 1+ϵ_{high}) of the range and a baseline (i.e., 1) of the range. In some examples, the value of ϵ_{high} may be greater than the value of ϵ_{low} There is more room for the increase of low-probability tokens by increasing the value of ϵ_{high}. The value of ϵ_{low} may be kept relatively small, because increasing it will suppress the probability of these tokens to 0, resulting in the collapse of the sampling space.

In the context of RL for complex reasoning tasks, some tasks demonstrate low accuracy, with the majority of training samples yielding incorrect answers. Traditional optimization strategies that suppress the generation probability of erroneous samples suffer from inefficiency during RL training, as the trial-and-error mechanism incurs substantial computational costs. Given this challenge, it is critical to maximize the utility of correct answers when they are sampled by the language model 235. In some embodiments, if the second response 230 of the plurality of second responses is positive (e.g., correct), a second loss may be based on the second response. Then, the language model may be trained based on the first loss and the second loss. In some examples, to address the challenge, an imitation learning approach may be adopted by incorporating the second loss (e.g., an additional negative log-likelihood (NLL) loss) for the positive second responses (also referred to as correct answers) sampled during RL training of the language model 235. The second loss may be shown as follows:

$${ℒ}_{NLL} ( θ ) = - \frac{1}{{\sum }_{{o}_{i} ∈ 𝒯} \vert {o}_{i} \vert} {\sum }_{{o}_{i} ∈ 𝒯} {\sum }_{t = 1}^{\vert {o}_{i} \vert} log {π}_{θ} ( {a}_{t} \vert {s}_{t} ) \qquad ( 9 )$$

In Eq. (9), [symbol] denotes the set of correct answers. The second loss may be combined with the first loss through a weighting coefficient μ, which collectively serves as the objective for updating the language model 235. The second loss may be combined with the first loss as follows:

$$ℒ ( θ ) = {ℒ}_{PPO} ( θ ) + μ * {ℒ}_{NLL} ( θ ) \qquad ( 10 )$$

It is to be noted that the NLL loss is merely an example of the second loss and any appropriate loss may be used as the second loss. In this way, the utilization efficiency of positive samples may be enhanced during RL training process of the language model 235, thereby improving training efficiency.

In some embodiments, more than one second response of the plurality of second responses may be generated by the language model 235 based on one prompt. In some examples, the number of distinct prompts per batch is reduced and computational resources may be redirected toward repeated generations. Each prompt may be sampled more than once and more than one second response (e.g., positive and negative responses) may be generated based on one prompt. It is observed that sampling each prompt more once yields better performance than another approach (i.e., sampling each prompt only once), attributed to the richer contrastive signals it introduces, which enhances the learning capability of the language model 235.

FIG. 3 illustrates a flowchart of a process 300 for advantage generation in accordance with some embodiments of the present disclosure. The process 300 may be implemented at the model training system 110 or the model application system 110.

At block 310, the model training system 110 or the model application system 110 pretrains a value model based on respective returns for respective first tokens in a first response of a plurality of first responses output by a trained reference model. A return for a first token indicates a cumulative reward from the first token to an end of the first response.

At block 320, the model training system 110 or the model application system 110 generates, αt least based on the pretrained value model, respective advantages for respective second tokens in a second response of a plurality of second responses output by a language model. An advantage for a second token indicates a cumulative reward for the second token relative to an average of cumulative rewards for candidate tokens at a position of the second token.

In some embodiments, the process 300 may further includes training, based on the respective advantages, the language model by reinforcement learning, a training objective of the reinforcement learning is configured to increase at least one of the respective advantages.

In some embodiments, pretraining the value model may include: generating, using the value model, respective predicted value scores for the respective first tokens in the first response; determining respective differences between the respective returns and the respective predicted value scores; and pretraining the value model based on the respective differences.

In some embodiments, the respective returns may be determined using generalized advantage estimation (GAE), a tuning parameter in the GAE for determining the respective returns are set to a first value based on a dependency of the respective returns on a long term reward.

In some embodiments, the respective advantages may be determined using generalized advantage estimation (GAE), a tuning parameter in the GAE for determining the respective advantages are set to a second value based on a dependency of the respective advantages on a long term reward.

In some embodiments, the second value may be further based on a length of the second response of the plurality of second responses.

In some embodiments, training the language model may include: determining respective individual losses for the respective second tokens in the second response, an individual loss for a second token is associated with an advantage for the second token; obtaining a first loss based on a sum of the respective individual losses and the number of the respective second tokens; and training the language model based on the first loss.

In some embodiments, a change between the language model and the language model after training may be limited to a range, and a distance between an upper limit of the range and a baseline of the range may be greater than a distance between a lower limit of the range and the baseline.

In some embodiments, training the language model may further include: in response to the second response of the plurality of second responses being positive, generating a second loss based on the second response; and training the language model based on the first loss and the second loss.

In some embodiments, more than one second response of the plurality of second responses may be generated by the language model based on one prompt.

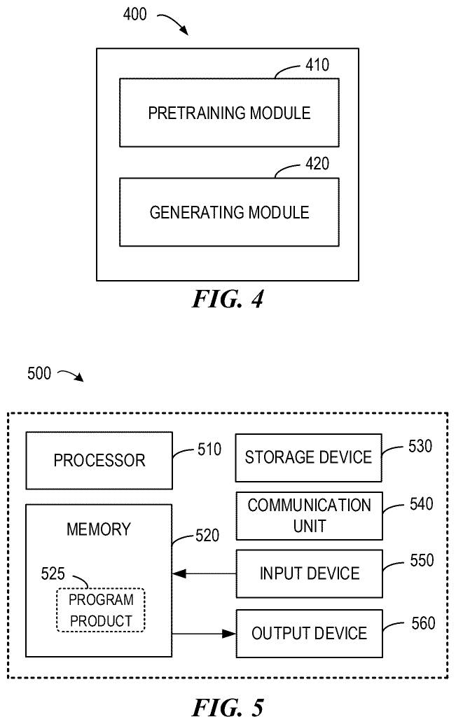

FIG. 4 shows a block diagram of an apparatus 400 for advantage generation in accordance with some embodiments of the present disclosure. The apparatus 400 may be implemented, for example, or included at the model training system 110 or the model application system 110 of FIG. 1. Various modules/components in the apparatus 400 may be implemented by hardware, software, firmware, or any combination thereof.

As shown, the apparatus 400 includes a pretraining module 410 configured to pretrain a value model based on respective returns for respective first tokens in a first response of a plurality of first responses output by a trained reference model, a return for a first token indicating a cumulative reward from the first token to an end of the first response; and a generating module 420 configured to generate, αt least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

In some embodiments, the apparatus 400 may further include a language model training module configured to train, based on the respective advantages, the language model by reinforcement learning, a training objective of the reinforcement learning is configured to increase at least one of the respective advantages.

In some embodiments, the pretraining module 410 is further configured to generate, using the value model, respective predicted value scores for the respective first tokens in the first response; determine respective differences between the respective returns and the respective predicted value scores; and pretrain the value model based on the respective differences.

In some embodiments, the respective returns may be determined using generalized advantage estimation (GAE), a tuning parameter in the GAE for determining the respective returns may be set to a first value based on a dependency of the respective returns on a long term reward.

In some embodiments, the respective advantages may be determined using generalized advantage estimation (GAE), a tuning parameter in the GAE for determining the respective advantages may be set to a second value based on a dependency of the respective advantages on a long term reward.

In some embodiments, the second value may be further based on a length of the second response of the plurality of second responses.

In some embodiments, the language model training module may be further configured to determine respective individual losses for the respective second tokens in the second response, an individual loss for a second token is associated with an advantage for the second token; obtain a first loss based on a sum of the respective individual losses and the number of the respective second tokens; and train the language model based on the first loss.

In some embodiments, a change between the language model and the language model after training may be limited to a range, and a distance between an upper limit of the range and a baseline of the range may be greater than a distance between a lower limit of the range and the baseline.

In some embodiments, the language model training module may be further configured to in response to the second response of the plurality of second responses being positive, generate a second loss based on the second response; and train the language model based on the first loss and the second loss.

In some embodiments, more than one second response of the plurality of second responses may be generated by the language model based on one prompt.

FIG. 5 illustrates a block diagram of an electronic device 500 in which one or more embodiments of the present disclosure can be implemented. It would be appreciated that the electronic device 500 shown in FIG. is only an example and should not constitute any restriction on the function and scope of the embodiments described herein. The electronic device 500 may be used, for example, to implement the model training system 110 or the model application system 130 of FIG. 1. The electronic device 500 may also be used to implement the apparatus 400 of FIG. 4.

As shown in FIG. 5, the electronic device 500 is in the form of a general computing device. The components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and can execute various processes according to the programs stored in the memory 520. In a multiprocessor system, multiple processing units execute computer executable instructions in parallel to improve the parallel processing capability of the electronic device 500.

The electronic device 500 typically includes a variety of computer storage medium. Such medium may be any available medium that is accessible to the electronic device 500, including but not limited to volatile and non-volatile medium, removable and non-removable medium. The memory 520 may be volatile memory (for example, a register, cache, a random access memory (RAM)), a non-volatile memory (for example, a read-only memory (ROM), an electrically erasable programmable read-only memory (EEPROM), a flash memory) or any combination thereof. The storage device 530 may be any removable or non-removable medium, and may include a machine-readable medium, such as a flash drive, a disk, or any other medium, which can be used to store information and/or data (such as training data for training) and can be accessed within the electronic device 600.

The electronic device 500 may further include additional removable/non-removable, volatile/non-volatile, transitory/non-transitory storage medium. Although not shown in FIG. 5, a disk driver for reading from or writing to a removable, non-volatile disk (such as a “floppy disk”), and an optical disk driver for reading from or writing to a removable, non-volatile optical disk can be provided. In these cases, each driver may be connected to the bus (not shown) by one or more data medium interfaces. The memory 520 may include a computer program product 525, which has one or more program modules configured to perform various methods or acts of various embodiments of the present disclosure.

The communication unit 540 communicates with a further computing device through the communication medium. In addition, functions of components in the electronic device 500 may be implemented by a single computing cluster or multiple computing machines, which can communicate through a communication connection. Therefore, the electronic device 500 may be operated in a networking environment using a logical connection with one or more other servers, a network personal computer (PC), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as required. The external device, such as a storage device, a display device, etc., communicate with one or more devices that enable users to interact with the electronic device 500, or communicate with any device (for example, a network card, a modem, etc.) that makes the electronic device 500 communicate with one or more other computing devices. Such communication may be executed via an input/output (I/O) interface (not shown).

According to example implementation of the present disclosure, a computer-readable storage medium is provided, on which a computer-executable instruction or computer program is stored, where the computer-executable instructions or the computer program is executed by the processor to implement the method described above. According to example implementation of the present disclosure, a computer program product is also provided. The computer program product is physically stored on a non-transient computer-readable medium and includes computer-executable instructions, which are executed by the processor to implement the method described above.

Various aspects of the present disclosure are described herein with reference to the flow chart and/or the block diagram of the method, the device, the equipment and the computer program product implemented in accordance with the present disclosure. It would be appreciated that each block of the flowchart and/or the block diagram and the combination of each block in the flowchart and/or the block diagram may be implemented by computer-readable program instructions.

These computer-readable program instructions may be provided to the processing units of general-purpose computers, special computers or other programmable data processing devices to produce a machine that generates a device to implement the functions/acts specified in one or more blocks in the flow chart and/or the block diagram when these instructions are executed through the processing units of the computer or other programmable data processing devices. These computer-readable program instructions may also be stored in a computer-readable storage medium. These instructions enable a computer, a programmable data processing device and/or other devices to work in a specific way. Therefore, the computer-readable medium containing the instructions includes a product, which includes instructions to implement various aspects of the functions/acts specified in one or more blocks in the flowchart and/or the block diagram.

The computer-readable program instructions may be loaded onto a computer, other programmable data processing apparatus, or other devices, so that a series of operational steps can be performed on a computer, other programmable data processing apparatus, or other devices, to generate a computer-implemented process, such that the instructions which execute on a computer, other programmable data processing apparatus, or other devices implement the functions/acts specified in one or more blocks in the flowchart and/or the block diagram.

The flowchart and the block diagram in the drawings show the possible architecture, functions and operations of the system, the method and the computer program product implemented in accordance with the present disclosure. In this regard, each block in the flowchart or the block diagram may represent a part of a module, a program segment or instructions, which contains one or more executable instructions for implementing the specified logic function. In some alternative implementations, the functions marked in the block may also occur in a different order from those marked in the drawings. For example, two consecutive blocks may actually be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by the combination of dedicated hardware and computer instructions.

Each implementation of the present disclosure has been described above. The above description is example, not exhaustive, and is not limited to the disclosed implementations. Without departing from the scope and spirit of the described implementations, many modifications and changes are obvious to ordinary skill in the art. The selection of terms used in this article aims to best explain the principles, practical application or improvement of technology in the market of each implementation, or to enable other ordinary skill in the art to understand the various embodiments disclosed herein.

What is claimed is:

1. A method for advantage generation, comprising:
pretraining a value model based on respective returns for respective first tokens in a first response of a plurality of first responses output by a trained reference model, a return for a first token indicating a cumulative reward from the first token to an end of the first response; and
generating, αt least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

2. The method of claim 1, further comprising:
training, based on the respective advantages, the language model by reinforcement learning, a training objective of the reinforcement learning is configured to increase at least one of the respective advantages.

3. The method of claim 1, wherein pretraining the value model comprises:
generating, using the value model, respective predicted value scores for the respective first tokens in the first response;
determining respective differences between the respective returns and the respective predicted value scores; and
pretraining the value model based on the respective differences.

4. The method of claim 1, wherein the respective returns are determined using generalized advantage estimation (GAE), a tuning parameter in the GAE for determining the respective returns are set to a first value based on a dependency of the respective returns on a long term reward.

5. The method of claim 1, wherein the respective advantages are determined using generalized advantage estimation (GAE), a tuning parameter in the GAE for determining the respective advantages are set to a second value based on a dependency of the respective advantages on a long term reward.

6. The method of claim 5, wherein the second value is further based on a length of the second response of the plurality of second responses.

7. The method of claim 2, wherein training the language model comprises:
determining respective individual losses for the respective second tokens in the second response, an individual loss for a second token is associated with an advantage for the second token;
obtaining a first loss based on a sum of the respective individual losses and the number of the respective second tokens; and
training the language model based on the first loss.

8. The method of claim 7, wherein a change between the language model and the language model after training is limited to a range, and a distance between an upper limit of the range and a baseline of the range is greater than a distance between a lower limit of the range and the baseline.

9. The method of claim 7, wherein training the language model further comprises:
in response to the second response of the plurality of second responses being positive, generating a second loss based on the second response; and
training the language model based on the first loss and the second loss.

10. The method of claim 1, wherein more than one second response of the plurality of second responses is generated by the language model based on one prompt.

11. An electronic device, comprising:
at least one processor; and
at least one memory coupled to the at least one processor and storing instructions executable by the at least one processor, the instructions, upon execution by the at least one processor, causing the electronic device to perform operations comprising:
pretraining a value model based on respective returns for respective first tokens in a first response of a plurality of first responses output by a trained reference model, a return for a first token indicating a cumulative reward from the token to an end of the first response; and
generating, αₜ least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.

12. The electronic device of claim 11, wherein the operations further comprise:
training, based on the respective advantages, the language model by reinforcement learning, a training objective of the reinforcement learning is configured to increase at least one of the respective advantages.

13. The electronic device of claim 11, wherein pretraining the value model comprises:
generating, using the value model, respective predicted value scores for the respective first tokens in the first response;
determining respective differences between the respective returns and the respective predicted value scores; and
pretraining the value model based on the respective differences.

14. The electronic device of claim 11, wherein the respective returns are determined using generalized advantage estimation (GAE), a tuning parameter in the GAE for determining the respective returns are set to a first value based on a dependency of the respective returns on a long term reward.

15. The electronic device of claim 11, wherein the respective advantages are determined using generalized advantage estimation (GAE), a tuning parameter in the GAE for determining the respective advantages are set to a second value based on a dependency of the respective advantages on a long term reward.

16. The electronic device of claim 15, wherein the second value is further based on a length of the second response of the plurality of second responses.

17. The electronic device of claim 12, wherein training the language model comprises:
determining respective individual losses for the respective second tokens in the second response, an individual loss for a second token is associated with an advantage for the second token;
obtaining a first loss based on a sum of the respective individual losses and the number of the respective second tokens; and
training the language model based on the first loss.

18. The electronic device of claim 17, wherein a change between the language model and the language model after training is limited to a range, and a distance between an upper limit of the range and a baseline of the range is greater than a distance between a lower limit of the range and the baseline.

19. The electronic device of claim 17, wherein training the language model further comprises:
in response to the second response of the plurality of second responses being positive, generating a second loss based on the second response; and
training the language model based on the first loss and the second loss.

20. A non-transitory computer readable storage medium having computer executable instructions stored thereon, the computer executable instructions, when executed by an electronic device, causing the electronic device to perform operations comprising:
pretraining a value model based on respective returns for respective first tokens in a first response of a plurality of first responses output by a trained reference model, a return for a first token indicating a cumulative reward from the token to an end of the first response; and
generating, at least based on the pretrained value model, respective advantages for respective second tokens in a second response of a plurality of second responses output by a language model, an advantage for a second token indicating a cumulative reward for the second token relative to an average of cumulative rewards for candidate tokens at a position of the second token.
